(19) United States
(12) Patent Application Publication
(10) Pub. No.: US 2023/0297333 A1
(43) Pub. Date: Sep. 21, 2023

(54) Pro Sort

(71) Applicant: Conrad Lewis Gourley, Denver, CO (US)

(72) Inventor: Conrad Lewis Gourley, Denver, CO (US)

(21) Appl. No.: 17/576,764

(22) Filed: Jan. 14, 2022

(51) Int. Cl. G06F 7/24; G06F 17/18

(52) U.S. Cl. CPC G06F 7/24; G06F 17/18

(57) ABSTRACT

The method uses a linear method as its driver. This means for most datasets it will approach linear time.

It visits each element twice, first time to gather information & second time to place that element in its sorted position.

Under ideal conditions it is literally sorting in two passes [one visit to each element of the dataset] through the dataset.

The more uniform the magnitude distribution is the faster [the closer to linear time] it will be able to sort them.

Collisions, causing block shifts & insertions, caused by non-uniform distributions of magnitude across the elements is where it potentially bogs down.

The most divergent exceptions would be datasets who’s sorted curve is essentially a ‘stair step’ progression of magnitudes with a single mid-split ‘step’ being the worst case where it degenerates into a two part insertion sort which would be essentially N^2.

‘Stair steps’ are where a lot of values are equal or very close to equal with a sudden dramatic change to another set of values that are all equal or nearly equal.

A single or a few extreme outlier/error values on a single end of the dataset would not be a problem with the two segment projection curve, but extreme outliers on both ends of the dataset would be problematic, causing slow, N^2 sorting.

In the case of the highest & lowest values being exactly equal after the first dataset analysis pass an escape to ‘already sorted’ would be placed before moving any data.

Random datasets have a mostly uniform distribution and the two segment projection functions mean it has macro adaption to fit the weighting of the data to one end or the other of the magnitude range for moderately eccentric datasets.

Theoretical reasoning:

Validity of sorting:

All elements that map to address A are always less than all elements that map to address B (in an ascending magnitude ascending address concurrent sort example).

Therefore all initially adjacent projected elements are inherently in sorted order.

So any resulting contiguous blocks of projected/sorted elements are inherently sorted.

(Simply the functioning of continuous numerics.)

If any colliding elements are inserted into a sorted block so as to keep the sorted progression consistent then any expanded blocks retain sort coherence/integrity.

Since each block is the result of magnitude relative address projection any kissing/meeting blocks are also in sorted order.

QED

Theoretical Operational Basis:

One must understand that any sorted data [by definition] forms a monotonic curve, but in most cases with potentially very discontinuous sloping.

The ideal for this method is to find the closest mimic/approximation of that sorted curve that is a numerically continuous function/curve.

For example if one knew from experience that the data consistently fell on some portion of say a parabolic curve it could use that as the monotonic projection curve.

[Note that not only does one need to know what monotonic curve function to use, one also needs to know what section of that curve to use, & as well that section should come close to kissing the high & low endpoints.]

My original thought was to use the simplest linear projection from highest to lowest distributed across address space. This would have had many poor matches to the actual sorted curve of data.

Approximate ‘L’, arching & sagging sorted curves would have potentially been a poor match for the a simple linear projection.

The evolved/improved curve match is making it a two linear segment curve utilizing the highest, lowest & mean magnitude values.

This allows it significantly greater correlation with the actual sorted data curve. The curves match better. It increases the probability of closer proximate initial placement to each element’s final sorted position.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

Sorting is a primary operation of a good deal of software.

Speed of sorting is important & often critical in many applications. Graphics programs sort pixels & graphic element distances from a given viewpoint for display & speed is critical to the quality of user experience.

Data systems can operate more efficiently with faster sort methods.

In analytical simulation programs sort speed is probably very important. Genetic analysis almost certainly benefits from speedier sorting.

### BRIEF SUMMARY OF THE INVENTION

Pro sort projects & places the elements where it predicts they belong.

### Simplest Description

For each element the method calculates the predicted target address & if that address is available it places it there, if the target is already sorted/occupied it does a localized sort appropriate insertion/placement.

### More Detailed Description

[for this specific description [only] presume increasing magnitude correlates with increasing address]

It utilizes a continuous monotonic function to simply project/predict/map where a given element’s magnitude is most likely to belong based on its dataset relative magnitude.

To create that monotonic function it makes an initial pass [visiting each dataset element/address exactly once] through all the data elements determining the highest, lowest & mean of all the magnitudes.

The method calculates/‘constructs’ the monotonic projection function(s) particular to this dataset.

Because of likely ‘collisions’ [more than one element/value mapping/projecting to a single address] it must keep track of what has & has not yet been sorted with a bit flag array. That utilizes one bit per data element to be sorted. Each bitflag bit corresponds to a single array address.

The method takes the first unsorted element as the current element. Using the [crafted] monotonic function(s), it calculates the projected position/address for the/that current element’s magnitude.

If the calculated target address is as yet ‘unsorted’ (checking the bitflag array) it saves the value from the target position & copies the current value to the target address. It sets the bitflag corresponding to that target address. In most cases it then copies the target value to the current address. The exception is if the target & current addresses are the same/equal, in which case it must seek a new unsorted current element.

(The preceding/above is the linear time aspect of the algorithm.)

If the projected target address is already sorted [causing a ‘collision’] it must do a localized insertion/placement.

It either seeks incrementally up address if the current is greater than the value at the target address or incrementally down address if the current is less than the value at the target address.

If it finds an unsorted address at the continuous sorted appropriate address it saves the updated target value & copies the current value to that updated target address. It sets the bitflag that corresponds to the updated target address. It then checks to see if that updated target address is the same as the current address & if so seeks a new current [unsorted] address & if the addresses are not-the-same/not-equal it copies the updated target value to the current address & begins again. If in seeking/scanning through values it finds the current element needs to be between two adjacent sorted elements [a ‘trap’] it scans both up & down from that insertion point to see if the up address sorted block or down address sorted block is shorter [& available, having an unsorted beyond it]. It saves the unsorted displacement address value following the chosen block and then shifts the block, element by element, one address into that displacement address, opening up the insertion location & copies the current value to the opened location. It sets the bitflag corresponding to the displacement address.

It compares the displacement address with the current address & if not equal copies the saved displacement value to the current address.

If alternatively they are the same address the method seeks a new current value.

This continues until sorting is complete, placing or inserting each element exactly once.

Sort termination can either utilize an element counter or until all bitflag positions are ‘sorted’/set.

[Note: if one were looking for an arguably ‘perfect’, simple, recursive, strictly in place sort algorithm with strict linear time, that can sort any standard numeric data & one were willing to sign a binding, bonded, non-disclosure agreement we could discuss that algorithm/method instead. Putting a linear sort algorithm on its own virtually unhackable chip would possibly be the most commercially advantageous strategy, if that would be marketwise viable.]

### DETAILED DESCRIPTION OF THE INVENTION

Initially Pro sort scans each element of the array & finds/determines the highest, lowest & total dataset’s sum of all magnitude(s).

It calculates the mean [average].

From this information it creates a two joined linear segments projection curve. With N total elements the K [split point] address is determined.

### Two Segment Method Detail

The mean describes a rectangle of area of uniform magnitude across the address space/length & simultaneously the dataset’s total quantity of magnitude.

That said, the only relevant portion of that rectangle per the sorted curve is the rectangle from the low magnitude value to the mean magnitude, times the number of elements. That is the range of transition, relative magnitude differentiation.

From here let that be the understanding of the ‘mean rectangle’. ie. (the mean - low magnitude) times the element count rectangle.

For a concurrent ascending magnitude & address example one removes a triangle of area from the front top corner of the mean rectangle, rotates that triangle 180 degrees (Pi radians) & places it on the flat top of the remaining back of the mean rectangle.

One is creating a leading triangle that goes from the lowest magnitude to the mean magnitude and a triangle that goes from the mean magnitude to the highest magnitude which itself rests upon a base rectangle of that second portion of addresses times the mean magnitude.

Essentially one is sliding the transition address point up & down address at the mean magnitude until the total area under the curve matches the mean rectangle area.

Imagine a bungee cord pegged to the lowest & highest endpoints sliding through an ‘O’ loop that itself slides horizontally along the mean level to arrive at the point where the area under that two segment curve equals the mean rectangle area.

Relatively simple geometry & resulting algebra make it a non-onerous calculation to derive.

So with this improved method to calculate the target address one first compares a value/element to the mean magnitude & if it is higher or lower it chooses/uses that particular calculated linear segment to project to the target address.

....... Algebra Inset .....
H -> highest magnitude
L -> lowest magnitude
K -> split point
N -> element count
M -> mean magnitude
CE -> current element magnitude

Finding K, [note for ascending value sort; invert sequence for descending value sort]

This algebra (until target calculation) is simply & only to validate the final formula which is all the programmer has to use.
Mean rectangle: (M-L)N
Front triangle: (M-L)K/2
Rear triangle: (H-M) (N-K)/2
Base rectangle: (M-L)(N-K)
$$\begin{matrix}\left(\text{M} - \text{L}\right) \text{N =} \\ \left(\text{M} - \text{L}\right) \text{K} / 2 + \left(\text{H} - \text{M}\right) \left(\text{N} - \text{K}\right) / 2 + \left(\text{M} - \text{L}\right) \left(\text{N} - \text{K}\right)\end{matrix}$$
$$\begin{matrix}\text{all then divided by} \left(\text{M} - \text{L}\right) \\ \text{N =} \text{K} / 2 + \left(\text{H} - \text{M}\right) \left(\text{N} - \text{K}\right) / \left(2 \left(\text{M} - \text{L}\right)\right) + \left(\text{N} - \text{K}\right)\end{matrix}$$
$$\begin{matrix}\text{all * 2} \\ 2 \text{N = K +} \left(\text{H} - \text{M}\right) \left(\text{N} - \text{K}\right) / \left(\text{M} - \text{L}\right) + \text{2N} - \text{2K} \\ \text{K =} \left(\text{H} - \text{M}\right) \left(\text{N} - \text{K}\right) / \left(\text{M} - \text{L}\right) \\ \text{K} / \left(\text{H} - \text{M}\right) \text{=} \left(\text{N} - \text{K}\right) / \left(\text{M} - \text{L}\right) \\ = \text{N} / \left(\text{M} - \text{L}\right) - \text{K} / \left(\text{M} - \text{L}\right) \\ \text{K} / \left(\text{H} - \text{M}\right) \text{+} \text{K} / \left(\text{M} - \text{L}\right) = \text{N} / \left(\text{M} - \text{L}\right) \\ \left(\text{K} \left(\text{M} - \text{L}\right) + \text{K} \left(\text{H} - \text{M}\right)\right) / \left(\left(\text{M} - \text{L}\right) \left(\text{H} - \text{M}\right)\right) = \text{N} / \left(\text{M} - \text{L}\right) \\ \left(\text{K} \left(\text{M} - \text{L}\right) + \text{K} \left(\text{H} - \text{M}\right)\right) / \left(\text{H} - \text{M}\right) = \text{N} \\ \text{K} \left(\left(\text{M} - \text{L}\right) + \left(\text{H} - \text{M}\right)\right) = \text{N} \left(\text{H} - \text{M}\right) \\ \text{K} \left(\text{H} - \text{L}\right) = \text{N} \left(\text{H} - \text{M}\right) \\ \text{K =} \text{N} \left(\text{H} - \text{M}\right) / \left(\text{H} - \text{L}\right)\end{matrix}$$
N(H-M)/(H-L) = K ;this is the formula that goes into the method for determining ‘K’, the transition point/element. It is used exactly once, initially, for each given to be sorted dataset.

....... target calculation [used repeatedly for each element/value] ... if CE < M (( CE - L ) * K ) / ( M - L ) = target address [plus any non-zero sort array base address] if CE >= M

(( CE - M ) * ( N - K )) / ( H - M ) + K = target address [plus any non-zero sort array base address]

....... End Algebra Inset ..... The method allocates a bitflag array with one bit specific to each element/address, and clears/zeros all array correlating bits leaving any trailing bits (addresses beyond the working array bounds) in the last block as set/‘sorted’ [as ones].

### L0

Using the bitflag array it finds the first unsorted element [which initially is the first element] as the current element/address. [If this is the sort termination function, upon finding no unsorted elements within the bitflag array bounds it exits the sort]

This function can also update the lowest bitflag block available [with unsorteds/zeros in it] & the highest bitflag block available [with unsorteds/zeros in it] as well.

### L1

[if one is using an element counter test as the sort termination function the counter increment & sort exit would probably go here.]

It compares the current element to the mean.

If it is below the mean it calculates the target address from that projection segment.

If it is above or equal to the mean it calculates the target address from that projection segment.

[Note: A target address calculation overshoot will need recovery to the actual available array or segment inclusive bounding address. * ]

It checks to see if the target address is sorted.

If not it sets the bitflag for that address.

If the target is not the current element address it swaps the values & works with the new current element value. It then goes to L1.

If it is the current element address it seeks a new current element/address. It then goes to L0.

If the target address is sorted [a collision] it compares the current element with the target value and determines whether it must seek up address or down address to place/insert the current element in its sorted position.

### L2

It tests to see if it is at the end of the array first, if so it finds the nearest unsorted value & after saving that unsorted & setting its bitflag it blockshifts everything one address into that displacement address & places the current element at that end of the array. It tests to see if that displaced address is the current element’s address & if not it copies it to the current element address and goes to L1, otherwise it seeks a new current & goes to L0.

If the sorted value is not the end of the array it checks to see if the next address in the appropriate direction is sorted. If not, it sets that bitflag & checks to see if it is not the current element address & if not swaps them, otherwise it seeks a new current element.

If the next value is sorted it compares it to the current element. If it continues the same initial magnitude comparison relationship [or is equal] it loops to L2.

If it contradicts the initial magnitude comparison it has found the ‘trap’ insertion point between two sorted values and must open a space for the current element to be inserted.

It finds the nearest, if any, unsorted in the up address direction & flags it as ‘found’ if appropriate then it finds the nearest, if any, unsorted in the down address direction & flags it as ‘found’ if appropriate.*

It choses the only or shorter of either shift block & saves the unsorted displacement element (immediately beyond the block) & sets the displacement address’s bitflag. It saves the displacement value & shifts those sorted elements into the displacement address. Then it inserts the current element in the now open address. It checks to see if the displacement address is the same as the current & if not it replaces the current with the displacement value & goes to L1. If the addresses are the same it instead seeks a new current, goes to L0.

The above is the entirety of the sort process to its completion.

* one place this occurs when the slope of a projection segment is steep, generally greater than 45 degrees. It might occur at the address split point, but may not be a problem there.

Where it might be a problem is when negative values are involved it may overshoot on the low end of the array, as I experienced it overshooting on the high end of the array when using positive integers. It is an easy snippet of capture code included in the calculate target function to guard against that.

** one can create a potential quicker exit from the second shift block seek if the first shift block seek if the flag shows it exists & this cumulative block size exceeds that total block size. Done at the programmer’s considered discretion. The order of seeking of up address or down address shift block first is arbitrary & at the programmer’s discretion.

1. With a linear operation as its core driver, Pro sort will, on average, out perform most other sort algorithms.
